(19) United States
(12) Patent Application Publication
(10) Pub. No.: US 2012/0285763 A1
(43) Pub. Date: Nov. 15, 2012

(54) ROBOT FOR USE IN A PASSAGEWAY HAVING AN OBLONG SECTION

(75) Inventors: Richard Carl Polivka, Lemont, IL (US); Clayton Muenchmeyer, Danville, IN (US)

(73) Assignee: INA Acquisition Corp., Wilmington, DE (US)

(21) Appl. No.: 13/468,780

(22) Filed: May 10, 2012

Related U.S. Application Data
(60) Provisional application No. 61/484,509, filed on May 10, 2011.

(51) Int. Cl. B60K 5/00

(52) U.S. Cl. 180/291; 901/1

(57) ABSTRACT

A robot adapted for navigating a passageway having an oblong section includes an engine and a carriage. The carriage includes drive members for driving engagement with the interior surface of the passageway for moving the robot along the passageway. The robot may include a lower stabilizing mechanism for maintaining the robot in a generally upright orientation in the passageway as the robot travels along the passageway. The robot may include an upper stabilizing mechanism for engaging an upper portion of the interior surface of the passageway for increasing friction of the drive members on the interior surface of the passageway. The drive members may each include wheels having different thicknesses and may be angled outwardly to increase engagement of a bearing surface of the drive members with the interior surface of the passageway.

### FIELD OF THE INVENTION

The present disclosure generally relates to apparatus and methods for navigating a passageway. In particular, the present disclosure relates to a robot for use in passageways having an oblong section such as an egg-shaped section or an oval section.

### BACKGROUND OF THE INVENTION

This invention relates to apparatus and methods for navigating a passageway. For example, a passageway may be rehabilitated in a lining operation in which a resin-impregnated liner is inserted in the passageway, conformed to the general shape of the passageway, and cured to provide a new liquid tight lining on the interior surface of the passageway. Various aspects of lining operations require use of a robot for navigating the passageway to be rehabilitated. For example, the robot may be provided with a camera and moved along the passageway to survey conditions in the passageway before, during, or after a lining operation. Moreover, the robot may be equipped with tools such as cutting or drilling tools for performing various rehabilitation-related tasks. For example, the robot may be equipped with a cutting tool for trimming portions of lateral passageways protruding into the passageway to be lined. The robot may be equipped with a cutting tool to form an opening in an installed liner to reinstate a connection of the lined passageway with a lateral passageway. A robot adapted for executing various rehabilitation-related tasks is disclosed in co-assigned U.S. patent application Ser. No. 11/796,379, published as U.S. Patent App. Pub. No. 2007/0284876. Persons having ordinary skill in the art understand robots may be used for various tasks in passageways.

### SUMMARY

In one aspect of the present invention, a robot is provided for navigating a passageway. The passageway has a longitudinal axis and an interior surface including upper and lower interior surface portions. The lower interior surface portion has a central segment corresponding to a radial position of about 6 o'clock in the passageway with respect to the longitudinal axis. The lower interior surface portion has left and right side segments which are located clockwise and counter-clockwise, respectively, from the central segment with respect to the longitudinal axis. The robot includes an engine having a front end, a rear end, and a travel axis along which the robot is adapted for traveling and which in use is positioned generally parallel with the longitudinal axis of the passageway. The robot also includes a carriage connected to the engine. The carriage includes drive members positioned on opposite sides of the carriage. The drive members are positioned for driving engagement with the interior surface of the passageway and are operatively connected to the engine for being driven by the engine to cause the robot to travel along the passageway via the driving engagement with the interior surface of the passageway. The robot also includes a lower stabilizing mechanism adapted for maintaining the robot in a generally upright orientation in use as the robot travels along the passageway. The lower stabilizing mechanism extends downward for contacting the lower interior surface portion of the passageway to resist rotation of the robot in the passageway clockwise or counter-clockwise about the travel axis.

In another aspect of the present invention, a robot is provided for navigating a passageway. The passageway has a longitudinal axis and an interior surface including upper and lower interior surface portions. The robot includes an engine having a front end, a rear end, and a travel axis along which the robot is adapted for traveling and which in use is positioned generally parallel with the longitudinal axis of the passageway. The robot also includes a carriage connected to the engine. The carriage includes drive members positioned on opposite sides of the carriage. The drive members are positioned for driving engagement with the interior surface of the passageway and are operatively connected to the engine for being driven by the engine to cause the robot to travel along the passageway via the driving engagement with the interior surface of the passageway. The robot also includes an upper stabilizing mechanism extending upward for contacting the upper interior surface portion of the passageway.

In another aspect of the present invention, a robot is provided for navigating a passageway having a longitudinal axis and an interior surface. The robot includes an engine having a front end, a rear end, and a travel axis along which the robot is adapted for traveling and which in use is positioned generally parallel with the longitudinal axis of the passageway. The robot also includes a carriage connected to the engine. The carriage includes wheel assemblies positioned on opposite sides of the carriage. The wheel assemblies are positioned for driving engagement with the interior surface of the passageway and are operatively connected to the engine for being driven by the engine to cause the robot to travel along the passageway via the driving engagement with the interior surface of the passageway. The wheel assemblies each include an inner wheel and an outer wheel. The inner wheel has a first diameter and the outer wheel has a second diameter smaller than the first diameter.

### BRIEF DESCRIPTION OF THE DRAWINGS

FIG. 1 is a right rear perspective of a robot of one embodiment of the present invention positioned adjacent to a pipe having an oblong, or egg-shaped cross section;

FIG. 2 is a right elevation of the robot;

FIG. 3 is a rear elevation of the robot;

FIG. 4 is a top view of the robot;

FIG. 5 is a rear elevation of the robot in the pipe;

FIG. 6 is a front elevation of the robot in the pipe;

FIG. 7 is a rear perspective of a carriage of the robot partially mounted on an engine of the robot;

FIG. 8 is a left rear perspective of wheels of the carriage;

FIG. 9 is the carriage of FIG. 7 in another example pipe having an oblong section;

FIG. 10 is a left rear perspective of a lower stabilizing mechanism of the robot;

FIG. 11 is a left elevation of the lower stabilizing mechanism;

FIG. 12 is a perspective of the lower stabilizing mechanism separate from other components of the robot and having fewer wheels, the lower stabilizing mechanism being shown in a retracted position;

FIG. 13 is a view similar to FIG. 12 but showing the lower stabilizing mechanism in an extended position;

FIG. 14 is an end view of an example wheel configuration of the lower stabilizing mechanism shown in a schematic representation of a lower portion of a passageway having an oblong section;

FIG. 15 is a left elevation of an upper stabilizing mechanism of the robot, an arm of the upper stabilizing mechanism being shown in an extended position;

FIG. 16 is a left perspective of a portion of the upper stabilizing mechanism; and

FIG. 17 is a rear elevation of the robot having the arm of the upper stabilizing mechanism in a retracted position;

FIG. 18 is a rear elevation of another embodiment of a robot of the present invention in another example passageway having an oblong section;

FIG. 19 is a bottom view of yet another embodiment of a robot according to the present invention;

FIG. 20 is a view similar to FIG. 14 but showing a different example wheel configuration and a different schematic representation of a lower portion of a passageway having an oblong section

FIG. 21 is a left front perspective of a robot of yet another embodiment of the present invention; and

FIG. 22 is a right front perspective of the robot of FIG. 21.

Corresponding reference characters indicate corresponding parts throughout the drawings.

### DETAILED DESCRIPTION

The ability of a robot to maintain stability or remain generally upright in a passageway enhances the ability of the robot to navigate the passageway and to execute desired tasks within the passageway. Some passageways that require rehabilitation have an oblong section such as an egg-shaped section or an oval section. The shape of these types of passageways presents a challenge for the robot to maintain stability as it navigates the passageways. For example, while moving within a passageway having an oblong section, the robot may overturn or roll onto its side due to the particular shape of the passageway. These types of passageways may be formed by generally smooth-walled pipe but are often formed of concrete or brick and may have rather irregular interior surfaces, which presents an additional challenge for a robot to maintain stability. For example, the robot may overturn or roll onto its side due to encountering irregularities in the interior surface of the passageway. A robot that has lost stability or traction (e.g., rolled onto its side or otherwise lost contact of its wheels with the interior surface of the passageway) may not be able to recover its stability or traction (e.g., return to a generally upright position or position its wheels in contact with the interior surface of the passageway), move within the passageway, or execute desired tasks within the passageway.

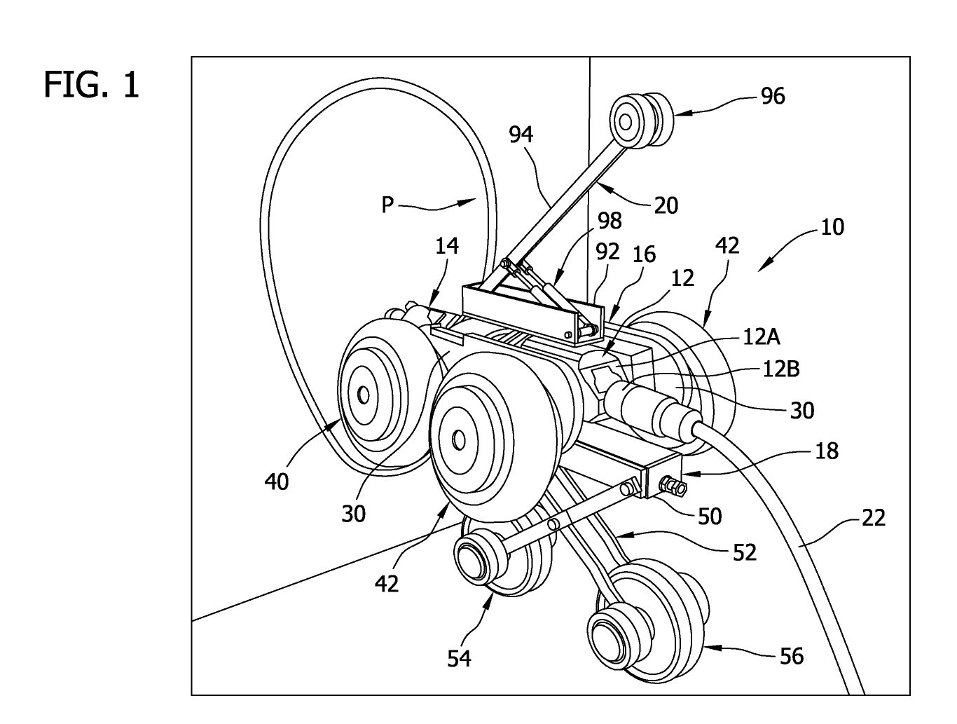

Referring now to the drawings and in particular to FIGS. 1-4, a robot constructed according to principles of the present invention is designated generally by the reference number 10. As explained in further detail below, the robot 10 is adapted for navigating passageways having an oblong section, such as an egg-shaped section or an oval section. FIG. 1 is a right side rear perspective of the robot 10 adjacent a pipe P (broadly, “a passageway”) having an egg-shaped section.

The robot 10 includes an engine 12, a head 14, a carriage 16, a lower stabilizing mechanism 18, and an upper stabilizing mechanism 20 (all designated generally). The engine 12 includes an elongate main body 12A which when the robot 10 is positioned in the pipe P is generally aligned with a flow path of the pipe. The engine 12 also includes a connector 12B for operatively connecting the engine with a power source and a controller (not shown) via a cord 22. The engine 12 is controllable remotely by the controller to cause the robot 10 to move within the pipe P and complete various tasks within the pipe. Various engines of this type are known and used in the industry. A person having ordinary skill in the art would be familiar with such engines. Accordingly, aspects of the engine 12 will not be discussed in further detail herein. Engines having configurations other than those shown or described herein may be used without departing from the scope of the present invention. Moreover, the robot may include a portable power source (e.g., batteries) and be wirelessly controllable such that the cord 22 may be omitted.

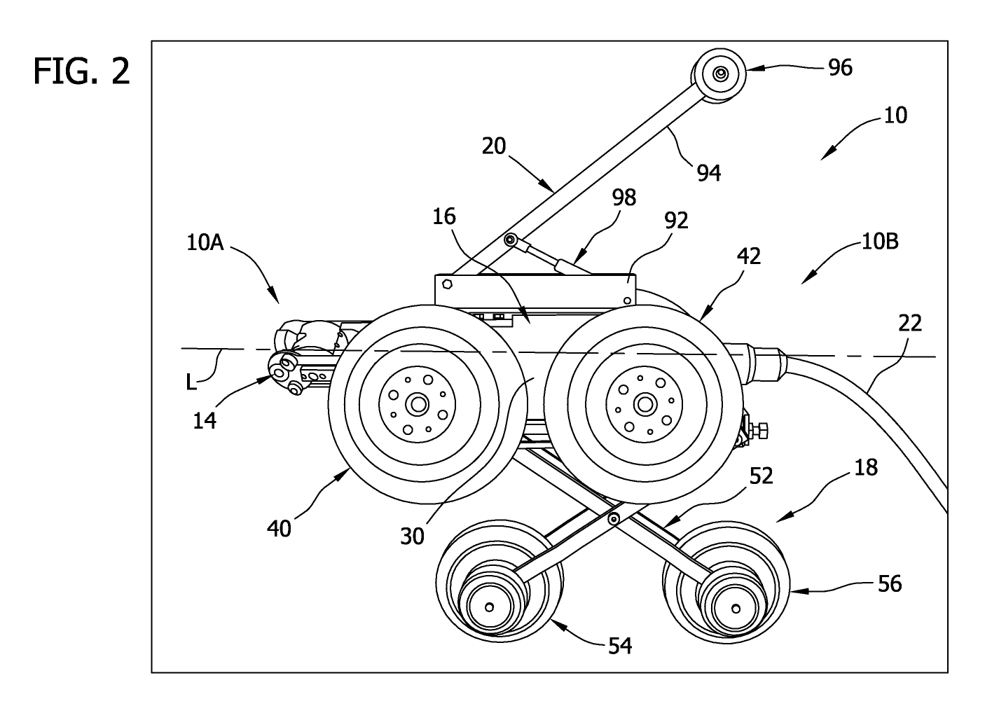

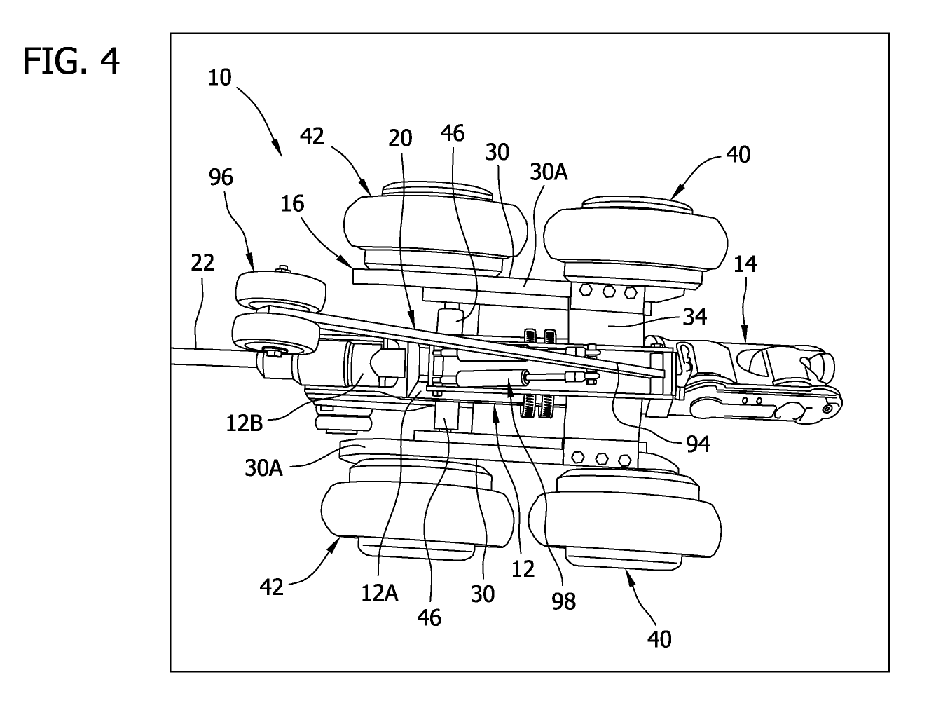

As shown in FIG. 2, the robot 10 has a front end, generally indicated by the reference number 10A, and a rear end, generally indicated by the reference number 10B. The robot 10 has a longitudinal axis (broadly “travel axis”) L extending between the front and rear ends which when the robot is in the pipe P is generally parallel to the flow path of the pipe. The connector 12B is positioned at the rear end 10B. The head 14 is positioned at the front end 10A. The head 14 is configured for rotating and pivoting with respect to the engine 12. FIG. 4 provides another view of the head 14. The head is adapted to be selectively equipped with various tools such as headlights, cameras, cutting tools, and other tools (not indicated or not shown) used in rehabilitation of pipes. Such tools are known and used in the pipe rehabilitation industry. A person having ordinary skill in the art would be familiar with such tools and attachment of the tools to the head 14 or other components of a robot 10. Accordingly, other aspects of the head 14 and the tools are not discussed in further detail herein. Heads or other tool attachment configurations other than those shown or described herein may be used without departing from the scope of the present invention.

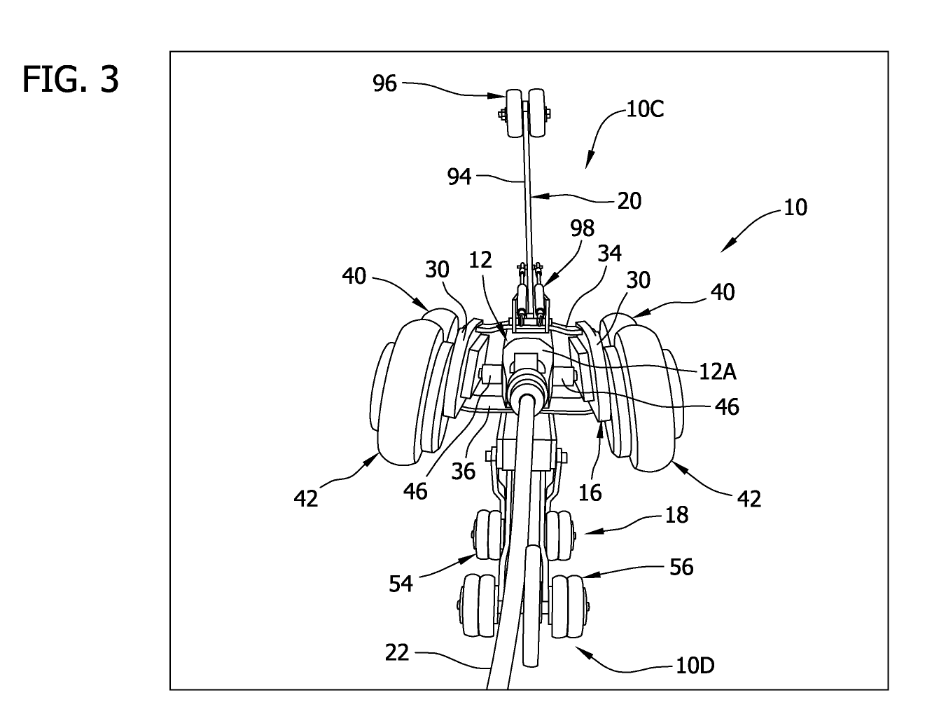

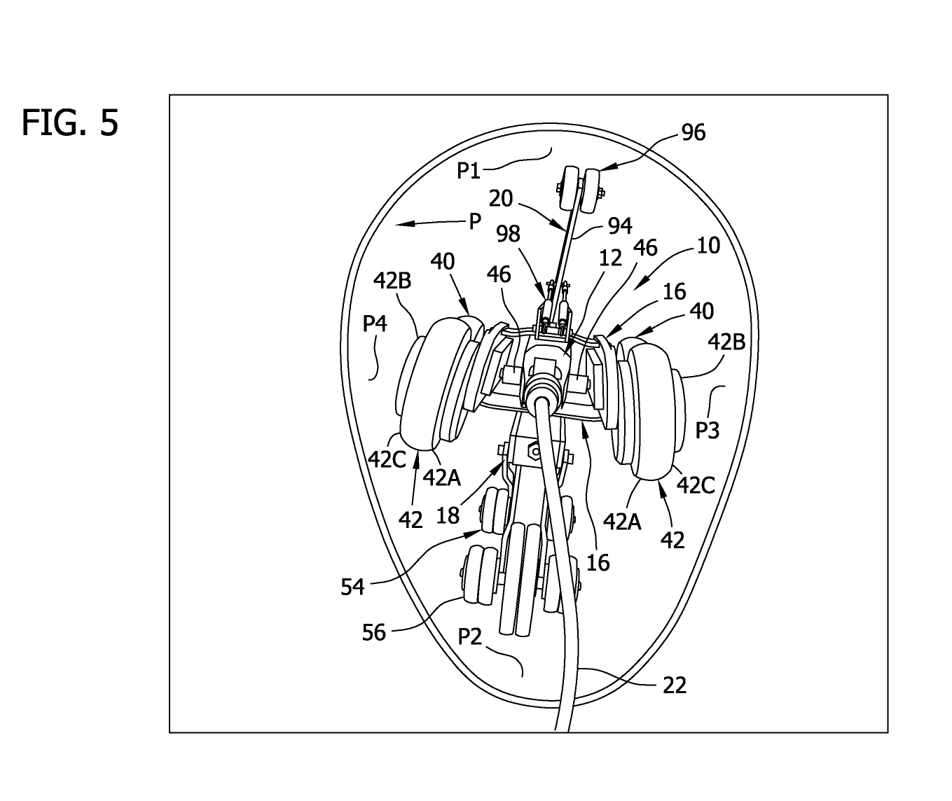

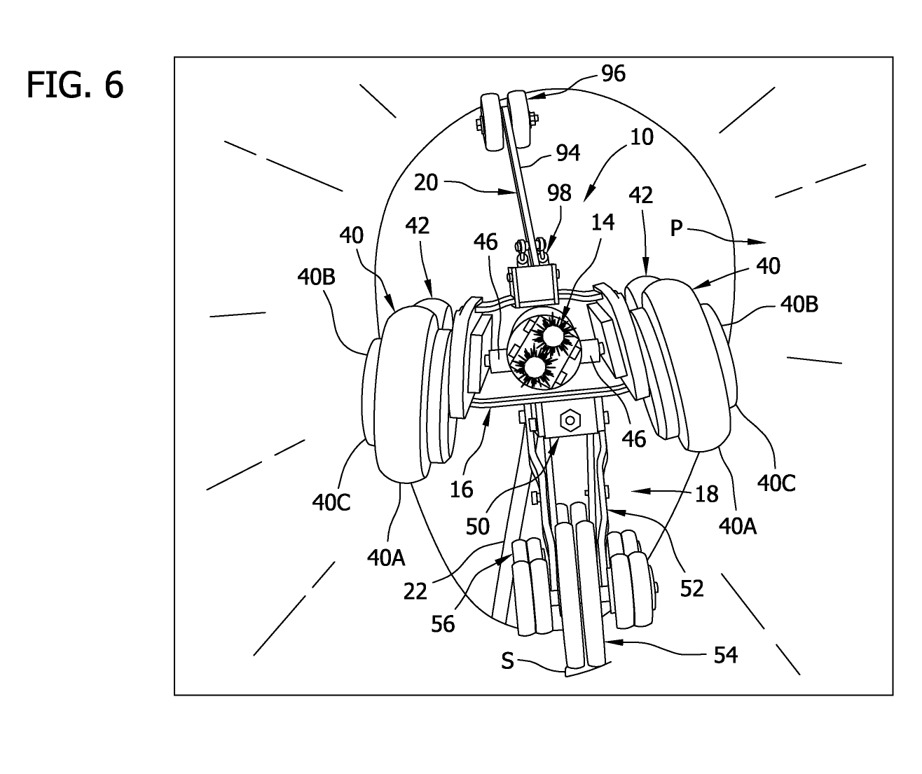

As shown in FIG. 3, the robot 10 has an upper end generally indicated by the reference number 10C, and a lower end generally indicated by the reference number 10D. FIG. 5 shows a rear elevation of the robot 10 in a generally upright orientation in the pipe P. FIG. 6 is a front elevation of the robot 10 in the pipe P. As explained in further detail below, the carriage 16, the lower stabilizing mechanism 18, and the upper stabilizing mechanism 20 are adapted to maintain stability of the robot 10 in the pipe P. For example, these components of the robot 10 facilitate maintaining the robot in the generally upright orientation while it navigates the pipe P. Stated another way, the carriage 16, the lower stabilizing mechanism 18, and the upper stabilizing mechanism 20 are adapted to generally prevent the robot from rotating in the pipe about the axis L (FIG. 2). In addition, these components assist the robot 10 in maintaining traction on the surface of the pipe P as the robot navigates the pipe.

The robot 10 is adapted for navigating pipes having different sizes, shapes, and degrees of internal surface irregularities. As shown in FIG. 5, the interior surface of the pipe P includes upper and lower portions P1, P2 and left and right side portions P3, P4. The example pipe P has an egg-shaped section having a size of about 2 feet (61 cm) wide by 3 feet (91 cm) tall. The upper portion P1 has a greater radius of curvature than the lower portion P2, providing the pipe P with its egg-shaped section. Egg-shaped pipes found in the field have various shapes and sizes. The pipes may be larger or smaller, and the radii of curvature of the upper and lower portions may vary. The robot 10 is adapted for navigating these egg-shaped pipes as well as other passageways having an oblong section, such as an elliptical or oval section or other modified circular sections. Moreover, the robot 10 may be used in passageways having sections including generally flat surfaces such as an oblong trapezoidal section. The robot 10 may be used in passageways having an oblong section other than those shown or described herein without departing from the scope of the present invention. As will become apparent, the robot 10 is fully adjustable for use in passageways having different shapes and sizes.

The pipe P shown in FIG. 1 has a generally smooth interior surface. Although pipes found in the field may have generally smooth interior surfaces, often times the pipes are formed of materials such as brick or concrete and may have relatively rough internal surfaces. For example, a brick pipe may have significant internal surface irregularities due to surfaces of individual bricks being out of register with each other, like bumps on a cobblestone road surface. As will become apparent, the robot 10 is adapted for navigating passages having smooth or rough internal surfaces. More specifically, the carriage 16, the lower stabilizing mechanism 18, and the upper stabilizing mechanism 20 are adapted for improving the stability and traction of the robot 10 for navigating pipes having these types of internal surfaces.

A pipe of the type the robot 10 is adapted for navigating may be a main pipe that has connections with lateral pipes which feed into or out of the main pipe. Main pipes having an oblong section often have lateral openings (not shown) in the side of the pipes at connections with lateral pipes feeding into the main pipes at radial positions corresponding to between about 1 and 3 o'clock and between about 9 and 11 o'clock. The main pipes often have lateral openings at connections with lateral pipes feeding out of the main pipes at radial positions corresponding to between about 4 and 6 o'clock and between about 6 and 8 o'clock. The carriage 16, lower stabilizing mechanism 18, and upper stabilizing mechanism 20 are configured for navigating pipes having lateral openings at these general positions. As will become apparent, these components are positioned to engage the interior surface of the pipe P at radial positions where they are less likely to encounter a lateral opening. However, if the carriage 16, lower stabilizing mechanism 18, or upper stabilizing mechanism 20 encounters a lateral opening or other discontinuity in the pipe, the others of the carriage, lower stabilizing mechanism, and upper stabilizing mechanism will maintain the stability and at least partial traction of the robot until the robot 10 moves past the lateral opening or discontinuity.

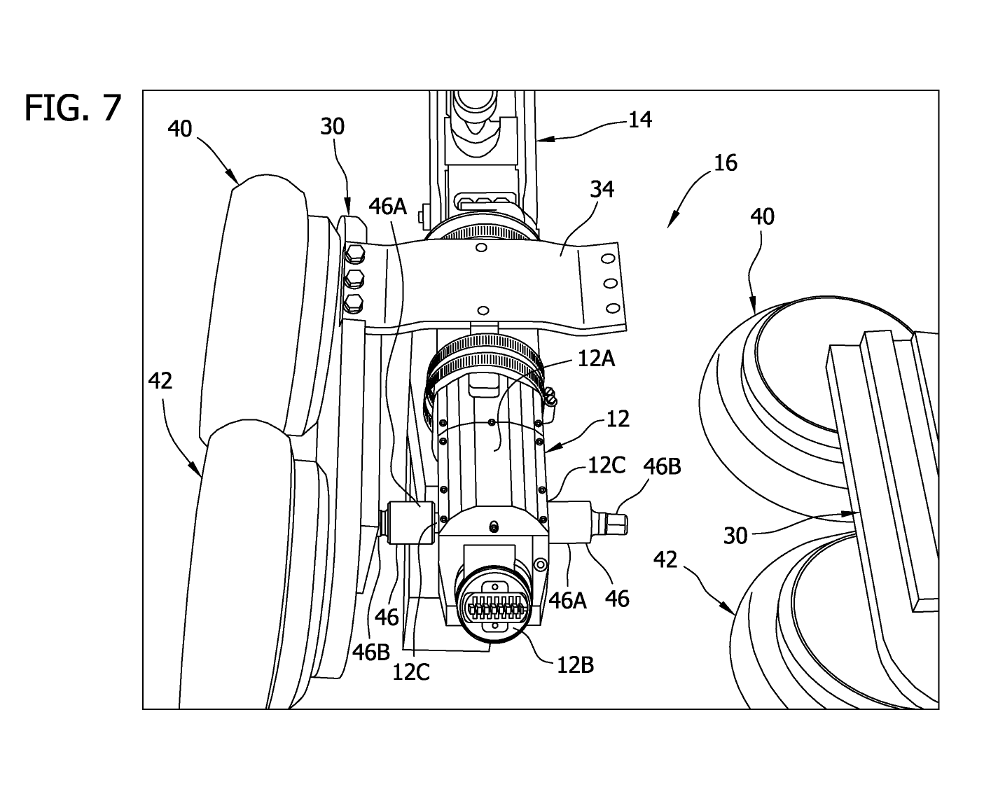

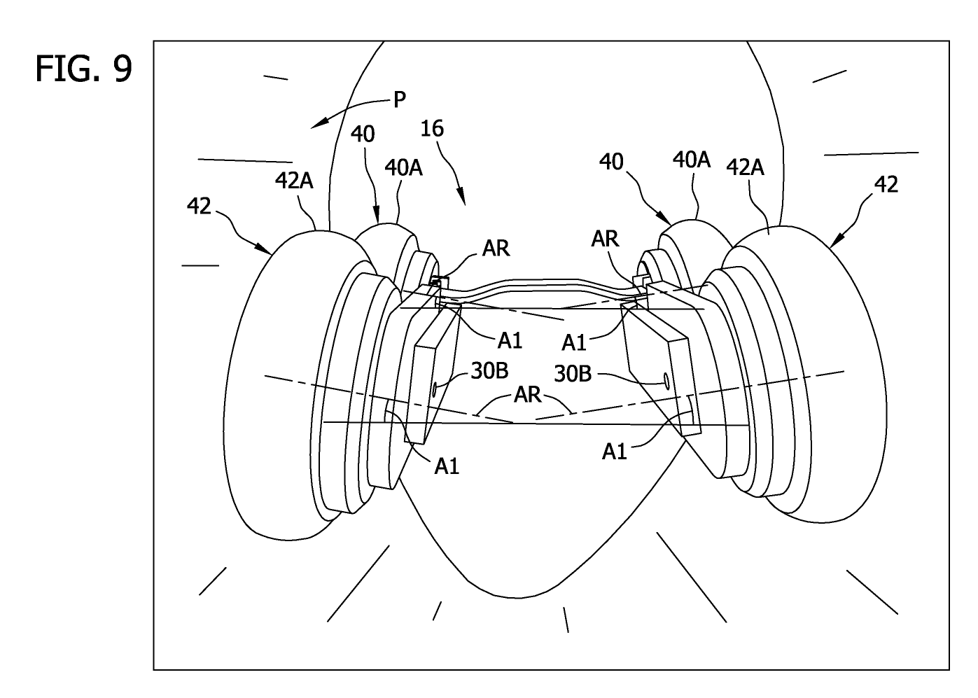

As shown in FIG. 3, the carriage 16 includes left and right side cartridges 30 connected by upper and lower braces 34, 36. As shown in FIG. 4, each cartridge 30 includes a body 30A and front and rear wheel assemblies 40, 42 (broadly “drive members”) connected to the body. When the robot 10 is inserted in the pipe P, the wheel assemblies 40, 42 contact the side portions P3, P4 of the internal surface of the pipe. For example, the wheel assemblies 40, 42 may be positioned for engaging portions of the interior surface of the pipe P corresponding to radial positions of about 3 and 9 o'clock to generally avoid encountering lateral openings in the pipe as described above. The engine 12 rotates the wheel assemblies 40, 42 to move the robot 10 forward and backward along the pipe P. FIG. 7 shows the carriage 16 partially assembled and partially mounted on the engine 12. The engine 12 has rotors 12C which are operatively connected to the cartridges 30 via respective universal connectors 46. The universal connectors 46 have sockets 46A that are received on the engine rotors 12C and heads 46B which are received in sockets 30B (FIG. 9) in the cartridges 30. Rotation of the universal connectors 46 by the engine rotors 12C causes the cartridges 30 to rotate the wheel assemblies 40, 42. The cartridge bodies 30A include internal components (not shown) which transfer the rotational force of the universal connectors 46 to the wheel assemblies 40, 42. For example, the cartridge bodies 30A may house gear trains or belt or chain drives suitable for such purpose. The cartridges 30 per se are not a subject of the present invention and will not be described in further detail herein. A person having ordinary skill in the art would understand various arrangements may be used to enable the engine 12 to rotate the wheel assemblies 40, 42. For example, the engine 12 may include a separate rotor for each wheel assembly.

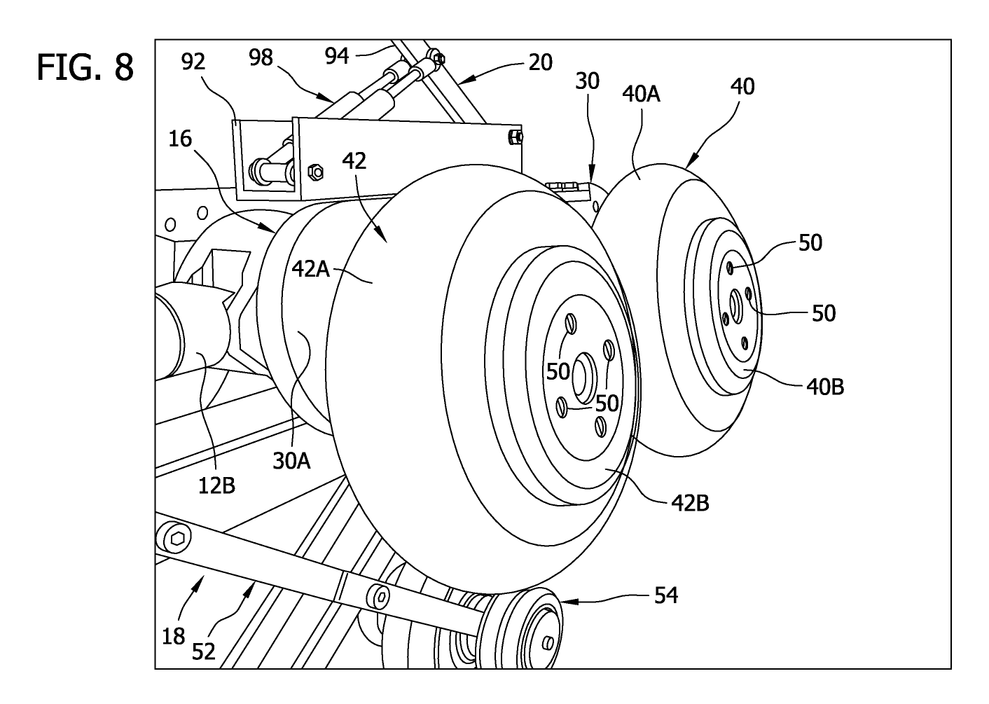

The wheel assemblies 40, 42 of the left side cartridge 30 are shown in closer detail in FIG. 8. Each wheel assembly 40, 42 includes inner wheels 40A, 42A and outer wheels 40B, 42B. The inner wheels 40A, 42A have a larger diameter than the outer wheels 40B, 42B and are thicker than the outer wheels. For example, in one embodiment the inner wheels 40A, 42A may have a diameter of about 10 inches (25.4 cm), and the outer wheels 40B, 42B may have a diameter of about 6.5 inches (16.5 cm). The outer wheels 40B, 42B are secured to the inner wheels 40A, 42A by screws 50 for conjoint rotation with the inner wheels. The arrangement of the inner and outer wheels 40A, 42A, 40B, 42B provides the wheel assemblies 40, 42 with an enhanced generally curved outer side profile for promoting contact of the wheel assemblies with the side portions P3, P4 of the internal surface of the pipe P. The sides of the inner wheels 40A, 42A at upper and lower portions of the inner wheels are curved. Use of the outer wheels 40B, 42B of smaller diameter on the side of the inner wheels 40A, 42A in effect extends the curved surface of the sides of the inner wheels at the upper and lower ends farther toward the axis of rotation of the inner wheels AR (FIG. 9). The combination of the inner larger diameter wheels 40A, 42A and the outer smaller diameter wheels 42A, 42B thus enhances the curvature on the outer side of the wheel assemblies 40, 42 to enhance contact of the wheel assemblies with the side portions P3, P4 of the surface of the passageway P. Depending on the orientation of the robot 10 in the pipe P and the shape, size, or condition of the interior surface of the pipe, the inner wheels 40A, 42A and outer wheels 40B, 42B of a respective wheel assembly 40, 42 may contact a side portion P3, P4 of the surface of the pipe P alone or in combination at any given time.

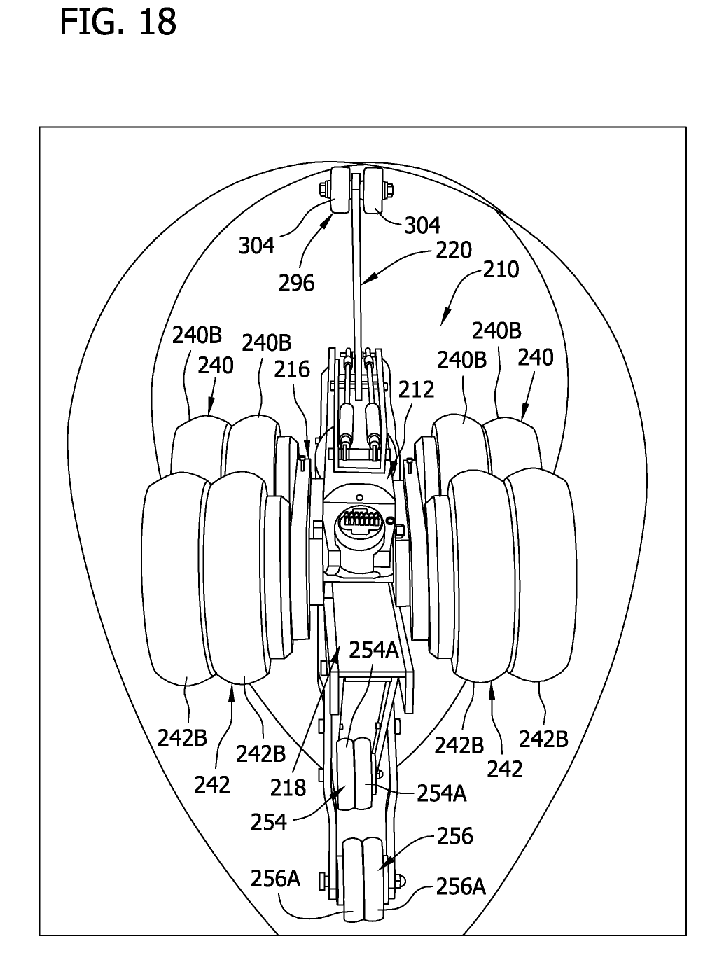

The carriage 16 is configured to enhance stability and traction of the wheel assemblies 40, 42 on the side portions P3, P4 of the surface of the pipe P. In particular, as shown in FIG. 5, each wheel assembly 40, 42 is angled outwardly from an upper end to a lower end to increase contact of a bearing surface 40C, 42C (FIG. 6) of each wheel assembly on a respective interior side surface P3, P4 of the pipe P. The wheels 40A, 40B, 42A, 42B of each wheel assembly 40, 42 each have radially outward facing circumferential bearing surfaces which combine to form the bearing surfaces 40C, 42C. FIG. 9 shows the carriage 16 (without the lower brace 36 and without the outer wheels 40B, 42B) in another example pipe P. As shown in FIG. 9, an axis of rotation AR of each wheel assembly has an angle A1 with respect to horizontal to position the bearing surface 40C, 42C at the lower end of the wheel assembly in improved contact with a respective interior side surface of the pipe P3, P4. The angled orientation of the wheel assemblies 40, 42 improves the traction and stability of the robot 10 in the pipe P because the bearing surfaces 40C rather than the side surfaces of the wheel assemblies are positioned for contact with the interior side surfaces P3, P4 of the pipe. The carriage shown in FIGS. 1-9 is configured so the angle A1 is about 15 degrees. Other angles may be used without departing from the scope of the present invention. For example, the angle A1 may be between about 10 degrees and about 45 degrees. In other embodiments, the angle A1 may be less than 15 degrees (e.g., 0 degrees as shown in FIG. 18) or greater than about 20, 25, 30, 35, 40, 45, or more degrees.

The wheel assemblies 40, 42 are adjustable to correspond to pipes having different shapes and sizes. The wheel assemblies 40, 42 may each include more or fewer wheels than shown (e.g., one wheel) or wheels having greater or less thickness than shown to increase or decrease the overall width of the carriage and enhance contact of the wheel assemblies with the interior side surfaces P3, P4 of the pipe P. For example, the wheel assemblies 40, 42 may include only the inner wheels 40A, 42A, as shown in FIGS. 7 and 9. Moreover, wheel assemblies may include multiple relatively large wheels such as wheels (see FIG. 18), optionally in combination with smaller wheels such as outer wheels 40B, 42B. Wheel assemblies having other combinations of more or fewer wheels and/or other sizes or profiles than shown or described herein do not depart from the scope of the present invention. Moreover, the wheel assemblies 40, 42 may be modified such as by positioning tracks (not shown) around wheel assemblies of respective cartridges 30 without departing from the scope of the present invention. In other words, a track (e.g., loop of rubber having external treads) may be positioned around both wheel assemblies of respective cartridges such that the wheel assemblies conjointly rotate the track and “contact” the inner surface of the pipe P via the tracks.

The lower stabilizing mechanism 18 enhances the stability and traction of the wheel assemblies 40, 42 on the interior surface of the pipe P. The lower stabilizing mechanism 18 serves as a support and/or a “rudder” for the robot 10. The lower stabilizing mechanism 18 is positioned below the engine 12 and extends downwardly below the bearing surfaces 40C, 42C of the wheel assemblies 40, 42. The lower stabilizing mechanism 18 provides support for the wheel assemblies 40, 42 and assists in maintaining the robot 10 in its generally upright orientation by assisting in preventing the robot from rotating in the pipe P about the axis L (FIG. 2). The lower stabilizing mechanism 18 is desirably configured for engaging portions of the lower interior surface P2 corresponding to radial positions of about 5 to 7 o'clock and more desirably about 6 o'clock to generally avoid encountering lateral openings in the pipe P as described above.

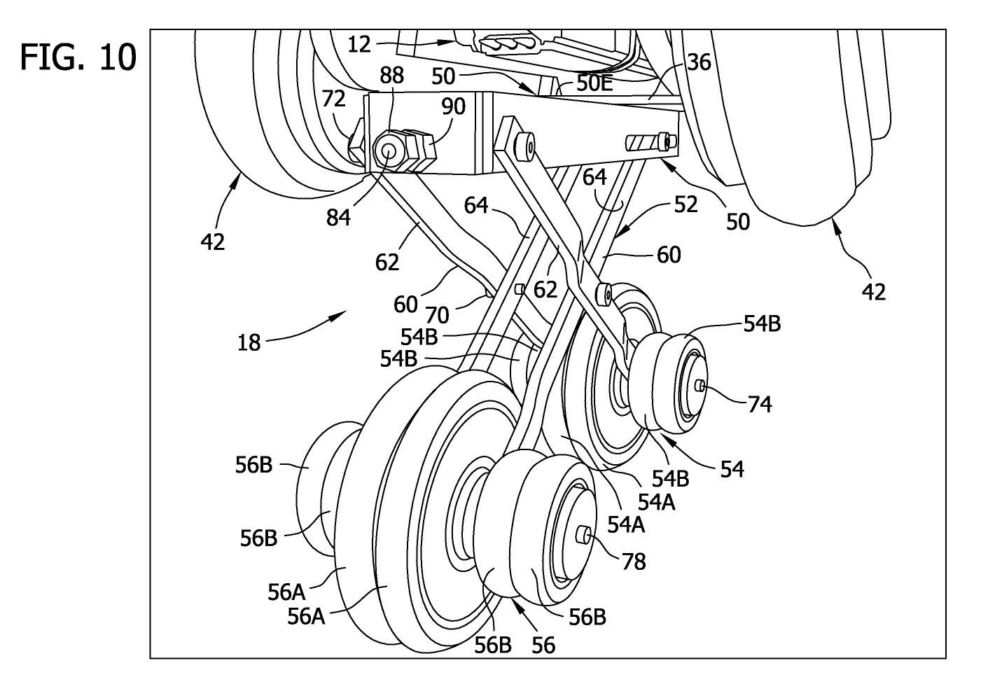

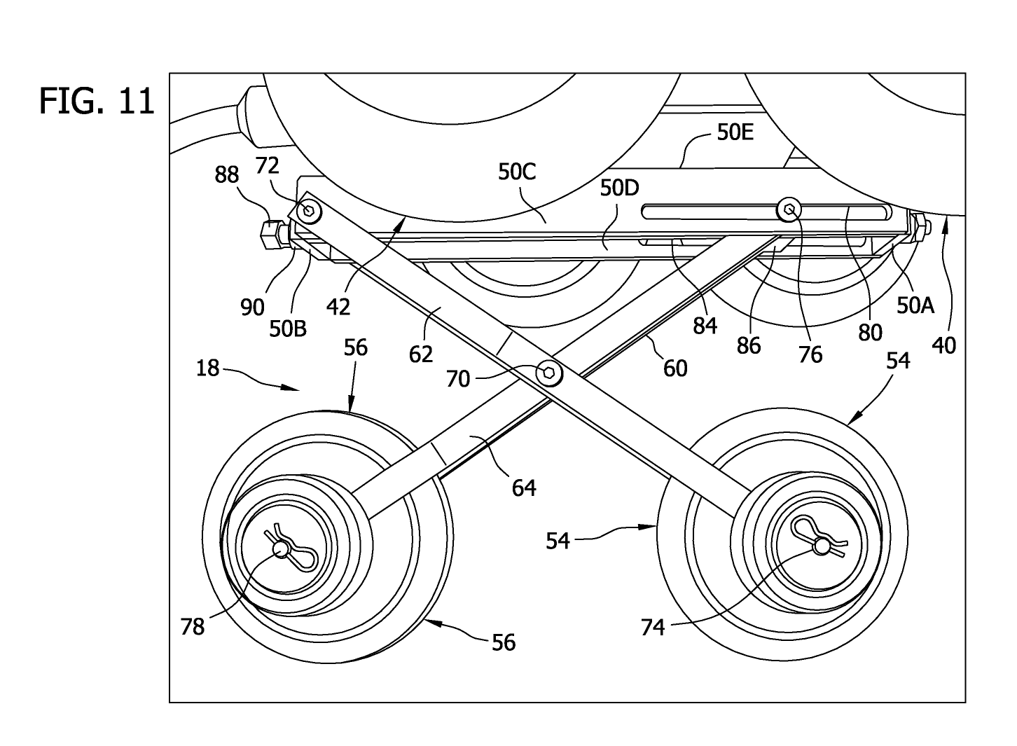

As shown in FIG. 10, the lower stabilizing mechanism 18 includes a frame 50, a scissors mechanism 52 (broadly “positioning assembly”), and front and rear wheel assemblies 54, 56 (broadly “engagement members”). As shown in FIG. 11, the frame 50 is elongate and extends along the length of the engine 12. The frame 50 has front and rear walls 50A, 50B, left and right walls 50C, 50D, an upper wall 50E, and an open bottom. The lower stabilizing mechanism 18 is mounted on the carriage 16 by suitable connection of the upper wall 50E of the frame 50 to the lower brace 36 (see FIG. 10). An upper end of the scissors mechanism 52 is mounted on the frame 50 and extends downwardly from the frame. The wheel assemblies 54, 56 are mounted on a lower end of the scissors mechanism 52.

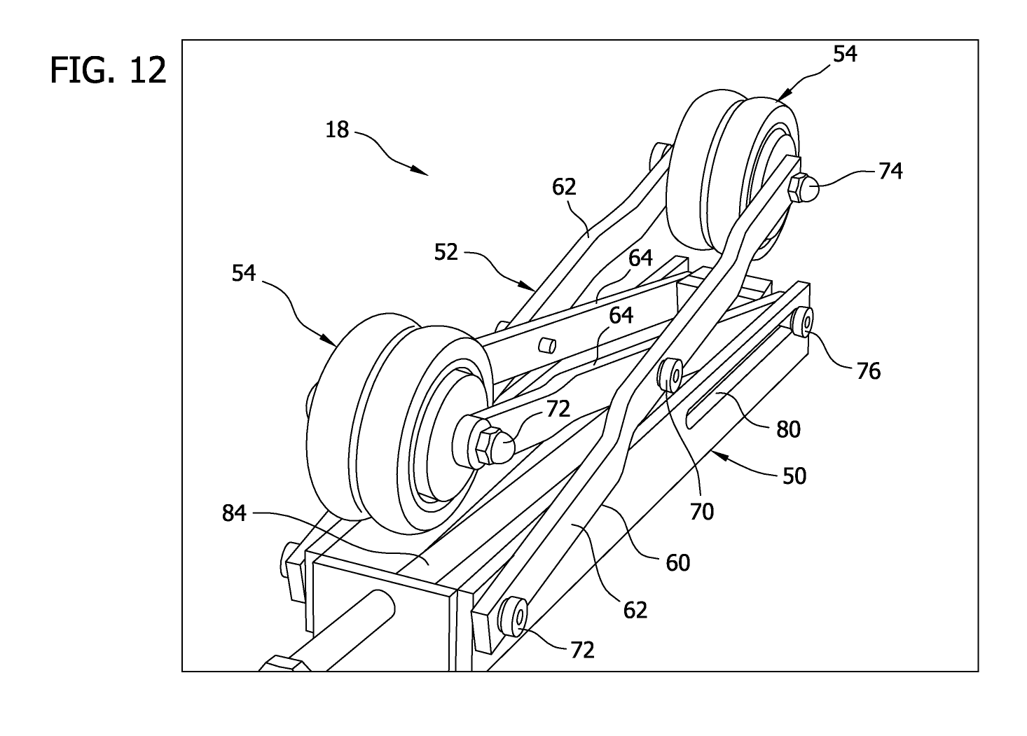

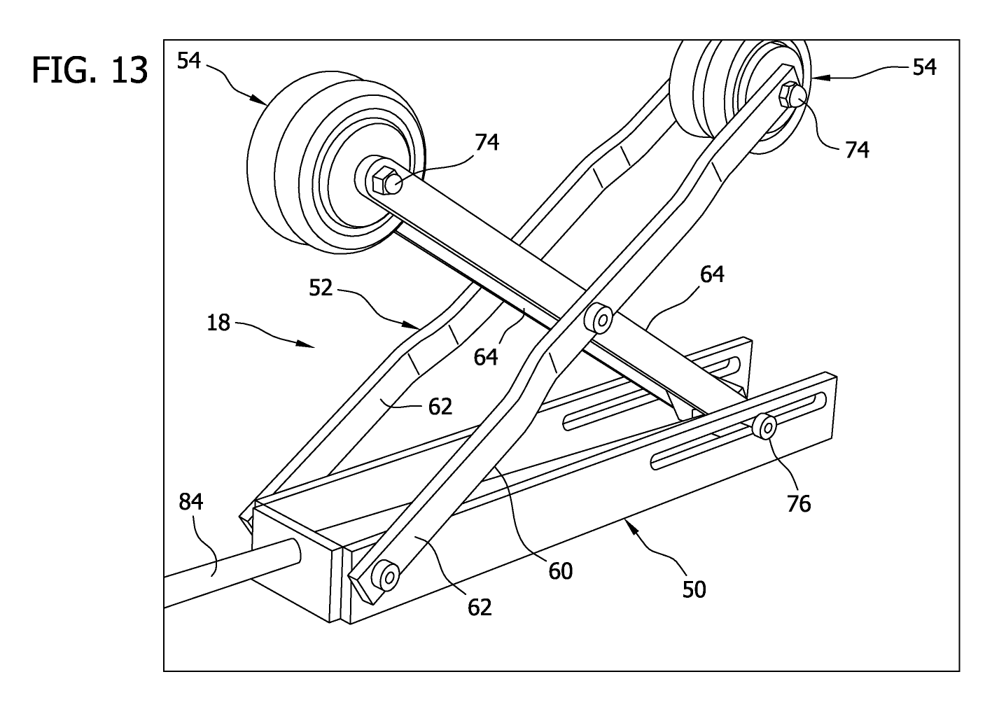

As shown in FIG. 10, the scissors mechanism 52 includes two pivot bar assemblies 60, one on each side of the frame 50. The pivot bar assemblies 60 are mirror images of each other. The pivot bar assembly 60 on the left side of the frame 50 will be described in further detail, with the understanding the pivot bar assembly 60 on the right side of the frame is constructed and operates essentially the same. As shown in FIG. 11, the pivot bar assembly 60 includes first and second pivot bars 62, 64 having a pivot (pin) connection 70 with each other about midway along their lengths. An upper end of the first pivot bar 62 has a pivot (pin) connection 72 at a rear end of the side wall 50C. A lower end of the first pivot bar 62 has a pin connection 74 with the front wheel assembly 54. An upper end of the second pivot bar 64 has a sliding pivot (pin) connection 76 in an elongate slot 80 at a front end of the side wall 50C. A lower end of the second pivot bar 64 has a pin connection 78 with the rear wheel assembly 56. The arrangement and connection of the pivot bars 62, 64 is such that the scissors mechanism 52 is movable between and extended position and a retracted position. FIG. 11 shows the scissors mechanism 52 in an extended position. FIGS. 12 and 13 show the lower stabilizing mechanism 18 being removed from the carriage 16 and inverted. FIG. 12 shows the scissors mechanism 52 in a retracted position, and FIG. 13 shows the scissors mechanism 52 in an extended position.

The scissors mechanism 52 includes a threaded shaft 84 which is rotatable to move the scissors mechanism between the extended and retracted positions. As shown in FIG. 11, the threaded shaft 84 extends between the front and rear walls 50A, 50B of the frame 50. The threaded shaft 84 passes through non-threaded openings in the front and rear walls 50A, 50B and through a travel member 86 which is pivotally connected with the upper end of the pivot bars 64. The travel member 86 is in threaded engagement with the threaded shaft 84. More specifically, the threaded shaft 84 passes through an opening in the travel member 86 having threads corresponding to the threads on the shaft. The shaft 84 may be rotated from the rear end of the frame 50 (e.g., by rotating nut 88 fixed to the shaft) or from the front end of the frame to cause the travel member 86 to move forward or rearward in the frame. Forward motion of the travel member 86 causes the scissors mechanism 52 to retract, and rearward motion of the travel member causes the scissors mechanism to extend. The scissors mechanism 52 may be locked into a particular position by preventing rotation of the threaded shaft by tightening a nut 90 in threaded engagement with the threaded shaft 84 against the rear wall 50B of the frame 50. The lower stabilizing mechanism 18 may have other configurations without departing from the scope of the present invention. For example, the lower stabilizing mechanism 18 may include a positioning assembly other than a scissors mechanism. Moreover, the lower stabilizing mechanism 18 may be automatically adjustable in height (e.g., by operative connection of the scissors mechanism to the engine 12) so the height of the lower stabilizing mechanism may be adjusted as necessary while the robot navigates the pipe P.

In the embodiment shown in FIGS. 10, 11, and 14, the wheel assemblies 54, 56 comprise inner wheels 54A, 56A and outer wheels 54B, 56B. The inner wheels 54A, 56A have a larger diameter than the outer wheels 54B, 56B. For example, in one embodiment the inner wheels 54A, 56A may have a diameter of about 8 inches (20.3 cm), and the outer wheels 54B, 56B may have a diameter of about 4 inches (10.2 cm). More specifically, the wheel assemblies 54, 56 each include a set of two inner wheels 54A, 56A positioned between or inboard of the pivot bar assemblies 60 and two sets of two outer wheels 54B, 56B which are positioned outboard of respective pivot assemblies. The wheels 54A, 56A, 54B, 56B are connected to respective pivot bars 62, 64 by axles or pins 74, 78 that extend through the wheels and pivot bars. The wheels 54A, 56A, 54B, 56B rotate independently with respect to each other. The combination of the inner larger diameter wheels 54A, 56A and the outer smaller diameter wheels 54B, 56B provides the wheel assemblies 54, 56 with graduated side profiles for enhancing contact with the lower portion P2 and side portions P3, P4 of the pipe P. More specifically, the inner wheels 54A, 56A are positioned and sized for contacting and rolling on the lower surface P2 of the pipe P, and the outer wheels 54B, 56B are positioned and sized for contacting and rolling on the left and right side portions P3, P4 of the surface of the pipe adjacent the lower portion of the surface P2 of the pipe.

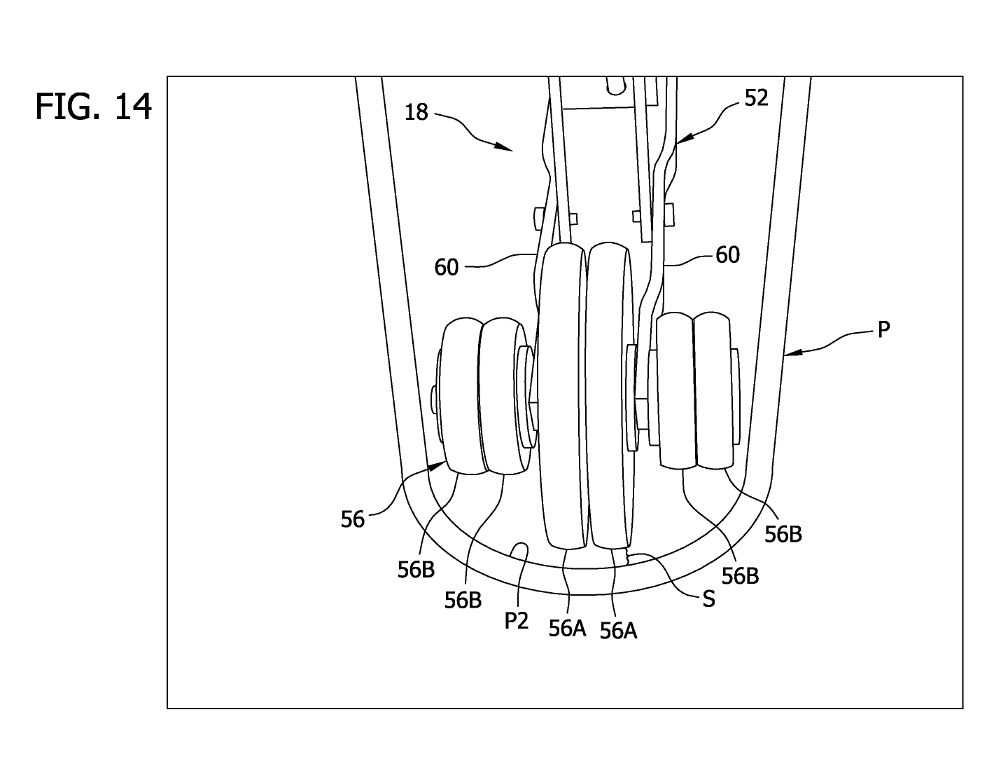

The front and rear wheel assemblies 54, 56 may be configured as desired for pipes having various shapes and sizes. For example, the wheel assemblies 54, 56 may include more or fewer wheels (e.g., one wheel each) or wheels of other diameters or thicknesses. The axles 74, 78 connecting the wheels may be replaced with longer or shorter axles when modifying the wheel assemblies 54, 56 to include more or fewer wheels or wider or thinner wheels. The wheel assemblies 54, 56 shown in FIGS. 10, 11, and 14 are configured for use in a pipe P having a relatively wide lower internal surface P2. For example, the wheel assembly 56 is shown in FIG. 14 in a schematic representation of a pipe P having a relatively wide lower internal surface P2. The wheel assemblies 54, 56 are shown in the example pipe P in FIGS. 5 and 6. The wheel assembly 56 is relatively wide. In general, if the width of the wheel assemblies 54, 56 is increased, the range of motion in which the robot 10 can rotate away from its generally upright position is decreased. In the same size pipe, a wheel assembly having a greater width permits less rotation of the robot 10 about axis L (FIG. 2) than a wheel assembly having a lesser width. This is because the sides of the wider wheel assembly contact the side portions P3, P4 of the surface of the pipe P in less severe rotational positions of the robot about axis L than if the narrower wheel assembly were used. As explained further below, other wheel assemblies (e.g., having other widths) may be used as desired. Moreover, the front wheel assembly 54 or rear wheel assembly 56 may be omitted. In addition, the wheel assemblies 54, 56 may be replaced with suitable structure such as a ski or other skid (not shown) without departing from the scope of the present invention.

As mentioned above, the lower stabilizing mechanism 18 enhances the stability and traction of the carriage wheel assemblies 40, 42 on the interior surface of the pipe P. The lower stabilizing mechanism 18 serves as a “rudder” in the sense that it maintains the robot 10 in the generally upright position as it moves along the pipe P. If the robot 10 begins to rotate about axis L (FIG. 2), either in a clockwise or counter-clockwise direction, the wheel assemblies 54, 56 of the lower stabilizing mechanism 18 contact the side surfaces P3, P4 of the pipe P to prevent further rotation of the robot. The lower stabilizing mechanism 18 serves as a support in the sense that the wheel assemblies 54, 56 may contact the lower surface P2 of the pipe P to provide support to the carriage wheel assemblies 40, 42. The scissors mechanism 52 is desirably adjusted to provide a suitable space S (FIGS. 6 and 14) of, for example, at least about 2.54, 5.08, 7.62 or more centimeters (about 1, 2, 3, or more inches), between the wheel assemblies 54, 56 and the lower surface P2 of the pipe P when the robot 10 is in an upright position, with the carriage wheel assemblies 40, 42 contacting the side surfaces P3, P4 of the pipe P. The space S between the wheel assemblies 54, 56 and the lower surface P2 assists in preventing the wheel assemblies from encountering a discontinuity in the lower portion of the pipe (e.g., debris or a raised brick) which might cause the wheel assemblies 40, 42 on the carriage 16 to lose traction or rise out of contact with the pipe surfaces P3, P4. The lower stabilizing mechanism 18 is positioned to contact the lower surface P2 of the pipe P if the robot 10 happens to slip downward in the pipe. For example, if the carriage wheel assemblies 40, 42 encounter a discontinuity in the side surfaces P3, P4 of the pipe P such as a lateral opening, one or more of the carriage wheel assemblies 40, 42 may lose contact or traction with the surface of the pipe and cause a portion of the robot 10 to move downwardly in the pipe. The wheel assemblies 54, 56 of the lower stabilizing mechanism 18 may contact and roll on the lower surface P2 of the pipe P until the carriage wheel assemblies 40, 42 regain contact or traction with the side surfaces P3, P4 of the pipe.

The lower stabilizing mechanism 18 may have other configurations without departing from the scope of the present invention. The lower stabilizing mechanism may be provided alone or in combination with other features (e.g., upper stabilizing mechanism) for enhancing the stability of the robot. Moreover, in some embodiments the lower stabilizing mechanism 18 may be omitted.

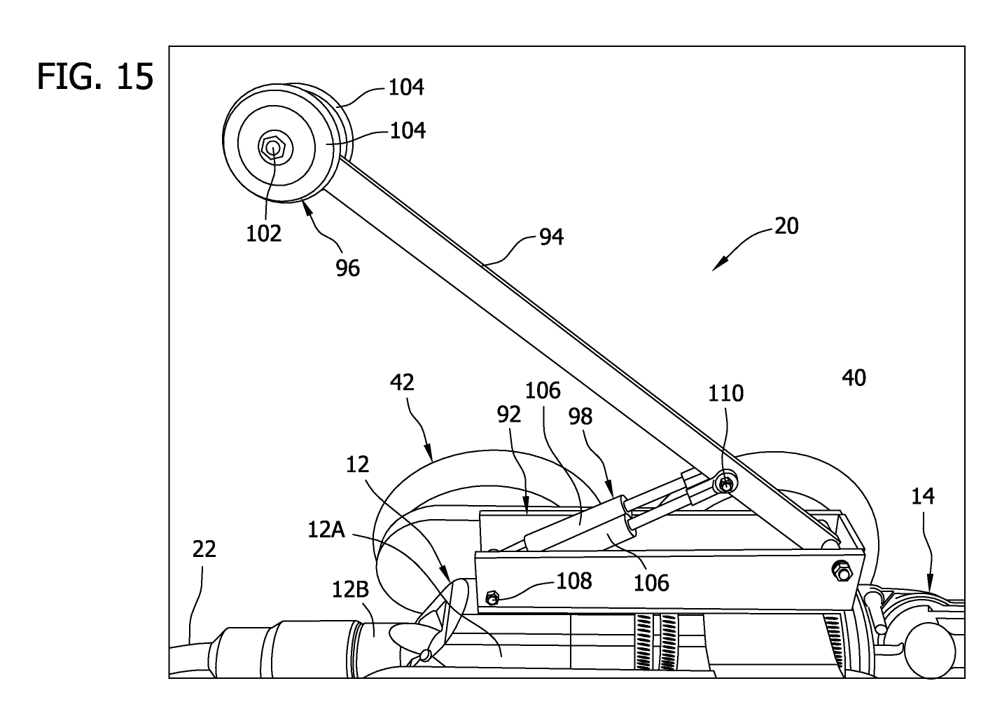

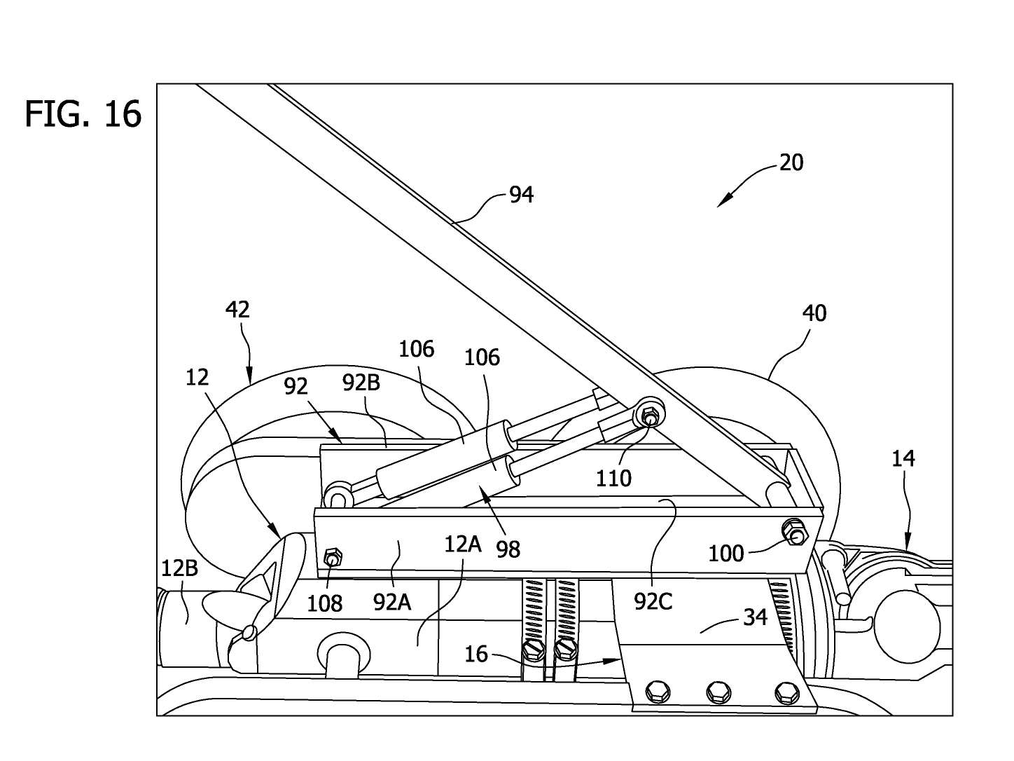

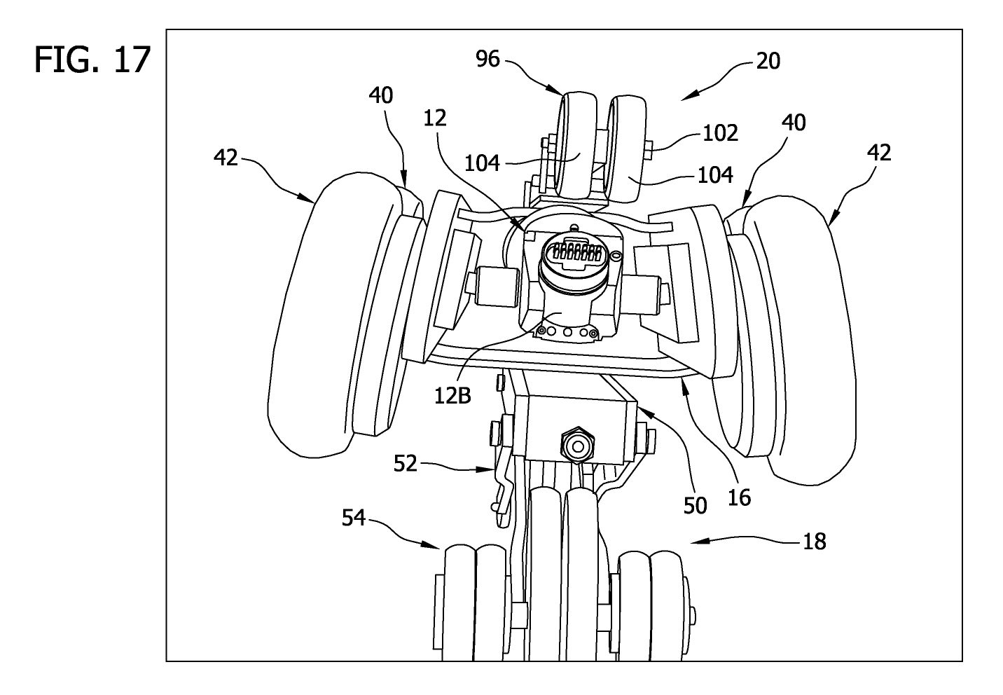

The upper stabilizing mechanism 20 may be used to enhance traction of the carriage wheel assemblies 40, 42 on the surface of the pipe P and/or enhance stability of the robot 10. Referring to FIG. 15, the upper stabilizing mechanism 20 includes a frame 92, an arm 94, a wheel assembly 96 (broadly “engagement member”), and a support assembly 98. FIG. 16 shows portions of the upper stabilizing mechanism 20 in closer detail. The frame 92 is elongate and extends along the length of the engine 12. The frame 92 has left and right walls 92A, 92B, a lower wall 92C, and an open top. The upper stabilizing mechanism 20 is mounted on the carriage 16 by suitable connection of the lower wall 92C of the frame 92 to the upper brace 34. A proximal end of the arm 94 has a pivot (pin) connection 100 with front ends of the left and right side walls 92A, 92B of the frame 92. The arm 94 is pivotable about the connection 100 to move the arm between raised and lowered positions. FIG. 17 shows the arm 94 in a lowered position. In this position, the arm 94 is generally parallel with the frame 92. When the robot 10 is deployed in the pipe P, the arm 94 is desirably in a raised position, such as shown in FIGS. 5 and 6. The upper stabilizing mechanism 20 is desirably configured for engaging portions of the upper interior surface of the pipe corresponding to radial positions of about 11 to 1 o'clock and more desirably about 12 o'clock to generally avoid encountering lateral openings in the pipe as described above. The arm 94 desirably deflects and extends as the robot 10 moves along the pipe P to maintain contact of the upper stabilizing mechanism 20 with the upper surface P1 of the pipe.

The wheel assembly 96 has a pivot (pin) connection 102 with a distal end of the arm 94. In the disclosed embodiment, the wheel assembly 96 includes wheels 104 on each side of the arm 94. An axle or pin 102 extends through the wheels 96A, 96B and an opening in the distal end of the arm 94. Other configurations of wheels having different combinations, numbers, sizes, and shapes may be used without departing from the scope of the present invention. The axle 102 may be replaced with a longer or shorter axle when modifying the wheel assembly 96 to include more or fewer wheels or wider or thinner wheels.

The support assembly 98 may be used to move the arm 94 to its raised position and maintain the arm in its raised position. In the disclosed embodiment, the support assembly 98 includes two hydraulic pistons 106. The pistons each apply a force of 20 pounds. Other strength pistons (e.g., 30 or 40 pounds) or other numbers of pistons (e.g., 1 or 3 or more) may be used without departing from the scope of the present invention. Proximal ends of the pistons have a pivot (pin) connection 108 with the left and right side walls 92A, 92B of the frame 92. Distal ends of the pistons have a pivot (pin) connection 110 with the arm 94 on opposite sides of the arm. Desirably, the pivot (pin) connections 108, 110 of the pistons 106 with the frame 92 and the arm 94 are positioned with respect to the pivot (pin) connection of the arm with the frame 100 to provide an “over center” arrangement. When the connection 110 moves “over center” above a line between the connection 100 and the connection 108, the pistons 106 apply force to the arm 94 tending to move the arm and maintain it in its raised position. When the connection 110 moves “over center” below the line between the connection 100 and the connection 108, the pistons 106 apply force to the arm tending to move the arm 94 and maintain it in its lowered position. Support assemblies other than disclosed herein may be used without departing from the scope of the present invention.

The upper stabilizing mechanism 20 enhances the traction of the carriage wheel assemblies 40, 42 on the surface of the pipe P by increasing the force with which the wheel assemblies engage the side surfaces P3, P4. For example, as the robot advances farther into the pipe, the length and thus the weight of the cord 22 which the robot is pulling increases. The upper stabilizing mechanism increases the length of the cord which the robot is capable of pulling (and the distance which the robot may be moved into the pipeline) because the upper stabilizing mechanism provides enhanced traction of the wheel assemblies on the interior surface of the pipe. The upper stabilizing mechanism 20 is desirably configured so the support assembly 98 maintains the wheel assembly 96 in contact with the upper surface P1 of the pipe P. When the robot 10 is positioned in the pipe, the arm 94 is desirably not in its fully raised position. Thus, the support assembly 98 biases the wheel assembly 96 against the upper surface P1 of the pipe. The force of the wheel assembly 96 against the upper surface P1 increases the force of the carriage wheel assemblies 40, 42 against the surface of the pipe P to enhance traction of the carriage wheel assemblies on the side surfaces P3, P4. If the upper stabilizing mechanism wheel assembly 96 encounters a recess in the upper surface P1 of the pipe P, the support assembly 98 may cause the arm 94 to rise sufficiently so the wheel assembly contacts the recessed surface of the pipe to continue to provide increased traction at the carriage wheel assemblies 40, 42. On the other hand, if the wheel assembly 96 encounters a protrusion in the upper surface P1, the support assembly 98 permits the arm 94 to deflect downward so the wheel assembly 96 does not substantially impede the movement of the robot 10 past the protrusion. It is noted the upper stabilizing mechanism may also be provided on robots adapted for navigating pipes having sections other than an oblong section (e.g., a circular section) for the same purpose of increasing traction of wheels on the interior surface of the pipe for facilitating movement of the robot along the pipe (e.g., farther into the pipe). Testing has indicated the upper stabilizing mechanism may improve traction by as much as 25% or more. For example, the robot may be able to travel about 400 feet along the pipe without the upper stabilizing mechanism and about 500 feet along the pipe with the upper stabilizing mechanism.

The upper stabilizing mechanism 20 may assist in maintaining the robot 10 in its generally upright orientation as the robot moves along the pipe P. For example, if the robot 10 begins to rotate clockwise or counter-clockwise from its generally upright position, the wheel assembly 96 may contact a respective side surface P3, P4 of the pipe P to prevent further rotation of the robot. Moreover, the bias of the wheel assembly 96 against the upper surface P1 of the pipe may be sufficient to assist the robot 10 in maintaining its generally upright orientation. In other words, the bias of the support assembly 98 on the arm 94 may cause the arm to “seek” a radial position in the pipe P in which the arm 94 is extended as much as possible. Given the shape of the upper end of most pipes having an oblong shape, the arm 94 will likely tend to “seek” the uppermost portion of the pipe P at generally the middle of the pipe, which would assist in maintaining the robot 10 in its generally upright orientation.

Upper stabilizing mechanisms having other configurations may be used without departing from the scope of the present invention. For example, for pipes of other sizes or shapes, a longer arm may be used, stronger or weaker pistons may be used, and/or a differently configured wheel assembly (e.g., having one wheel) may be used. The upper stabilizing mechanism may be provided alone or in combination with other features (e.g., lower stabilizing mechanism) for enhancing the stability of the robot. Moreover, in some embodiments, the upper stabilizing mechanism 20 may be omitted. In addition, the upper stabilizing mechanism 20 may be automatically adjustable in position (e.g., by operative connection of selectively pressurized pistons to the engine) so the height of the upper stabilizing mechanism 20 may be adjusted as necessary while the robot 10 navigates the pipe P.

In use, the robot 10 is inserted in the pipe P such as shown in FIGS. 5 and 6 and navigated along the pipe to conduct various tasks. The carriage 16, lower stabilizing mechanism 18, and upper stabilizing mechanism 20 assist in maintaining the robot's generally upright orientation to maintain the carriage wheel assemblies 40, 42 in contact with the surface of the pipe P. This promotes traction of the carriage wheel assemblies 40, 42 with the side surfaces P3, P4 of the pipe and enables the robot 10 to reliably move along the pipe to complete desired tasks.

FIG. 18 shows another embodiment of a robot 210. The robot is similar to the robot 10 described above. For example, the robot 210 includes an engine 212, a carriage 216, a lower stabilizing mechanism 218, and an upper stabilizing mechanism 220. This robot 210 is different in that the wheel assemblies 240, 242 of the carriage 216 are not angled, the wheel assemblies 240, 242 of the carriage each include two relatively large diameter wheels 240B, 242B, the wheel assemblies 254, 256 of the lower stabilizing mechanism 218 include wheels 254A, 256A of relatively small diameter, and the wheel assembly 296 of the upper stabilizing mechanism 220 has wheels 304 of smaller diameter. In use, the robot 210 operates similarly to the robot 10 described above.

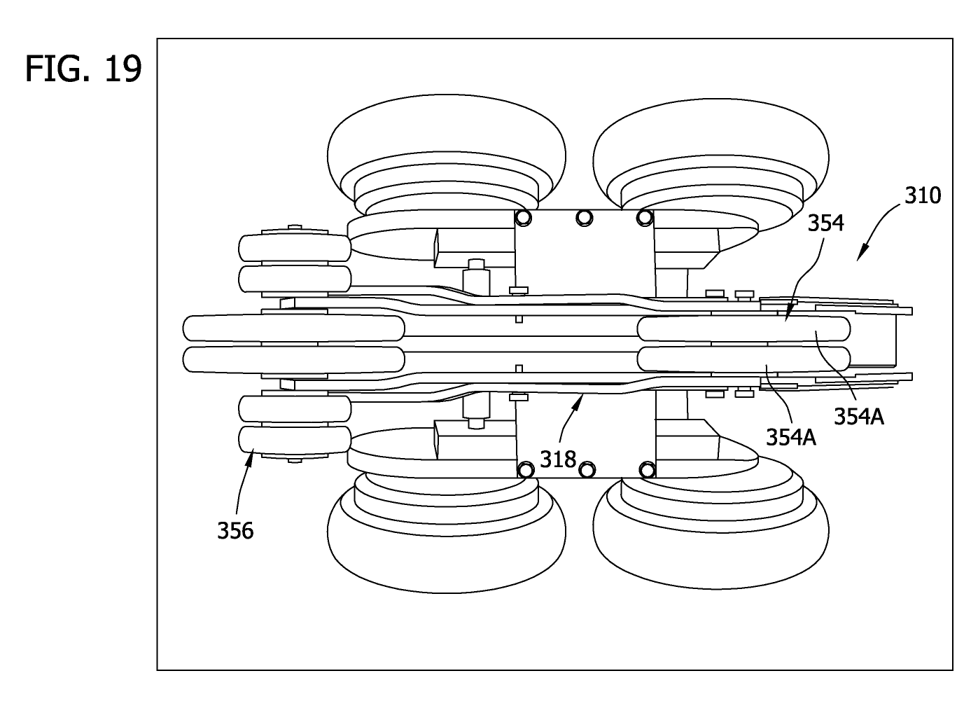

FIG. 19 shows a bottom view of another embodiment of a robot 310. The robot is similar to the robot 10 described above but the wheel assemblies 354, 356 on the lower stabilizing mechanism 318 have different configurations. The rear wheel assembly 356 is similar to the rear wheel assembly 56 described above. However, the front wheel assembly 354 includes only the wheels 354A.

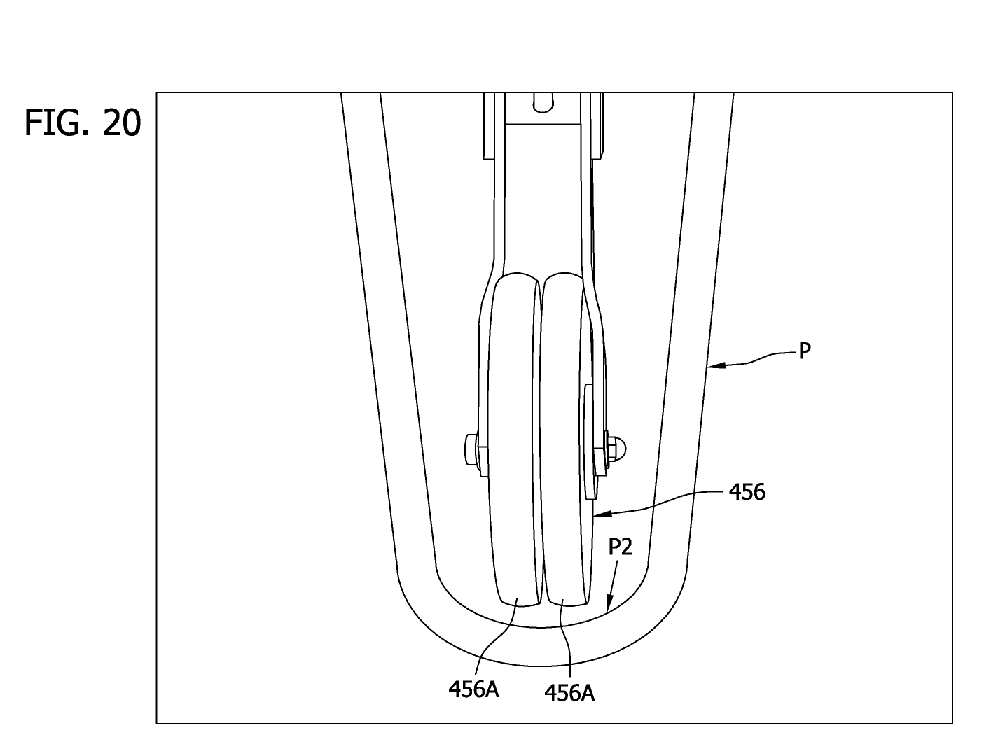

FIG. 20 shows yet another embodiment of a wheel assembly 456 that may be used on the front or rear ends of the lower stabilizing mechanism. The wheel assembly 456 is shown in a schematic representation of a pipe P having a relatively narrow lower internal surface P2. The wheel assembly 456 includes only the two wheels 456A to decrease the thickness of the wheel assembly to correspond to the general size and shape of the lower portion of the pipe section. The wheels 456A have a larger diameter than the wheels 254A, 256A shown in the embodiment in FIG. 18.

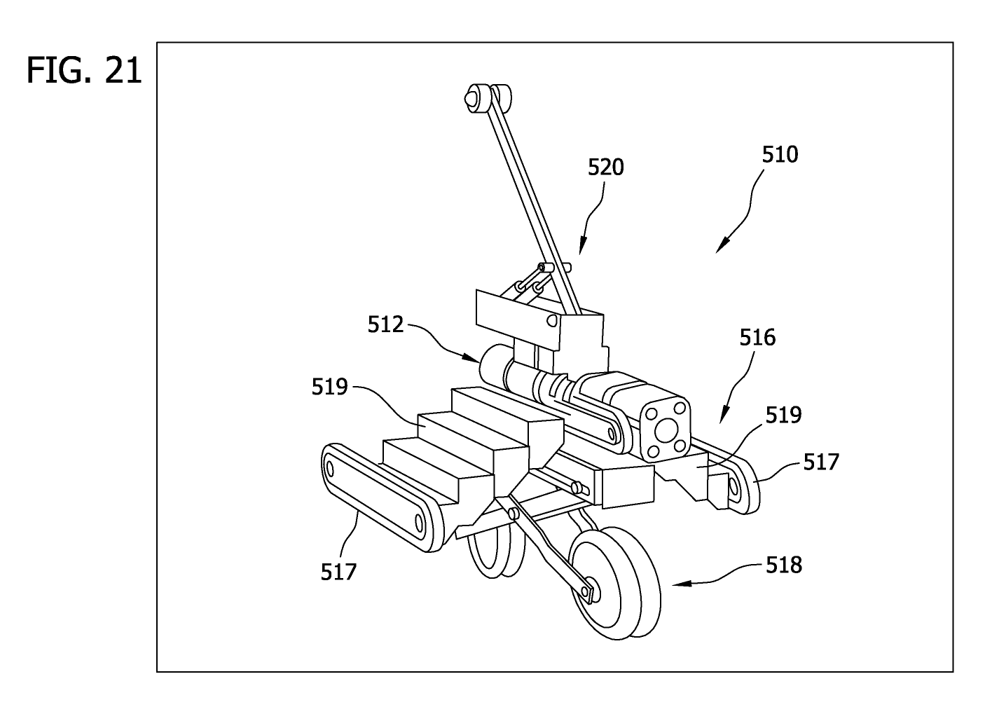

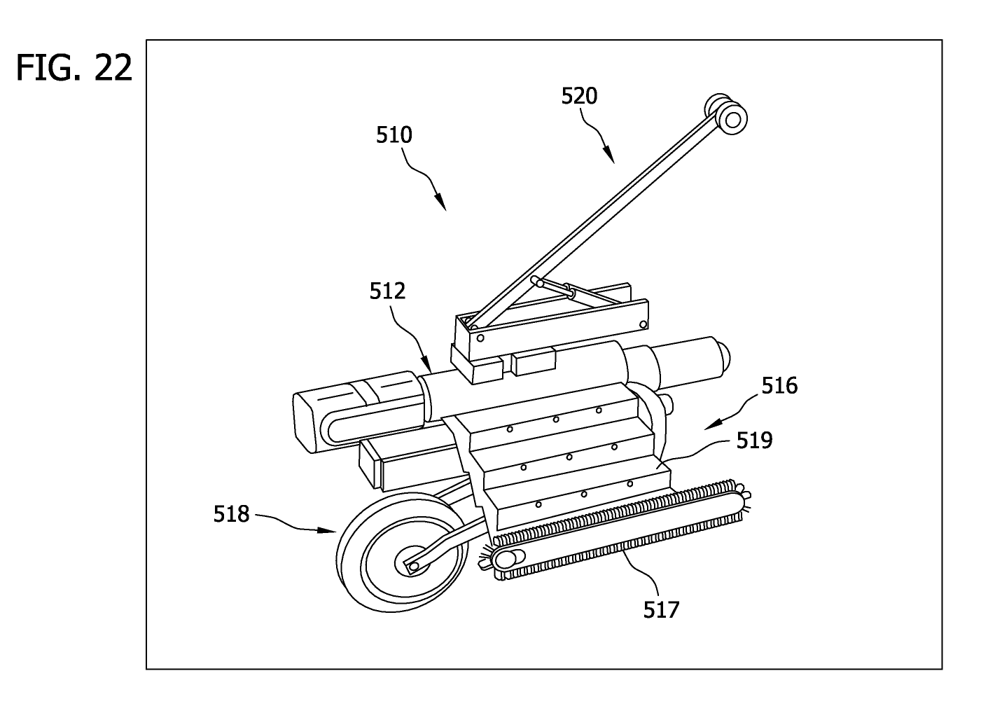

FIGS. 21 and 22 show yet another embodiment of a robot 510 of the present invention. Although the robot 510 may be used for other purposes without departing from the scope of the present invention, the particular robot shown is equipped with a camera for surveying a pipeline before and/or after a lining operation. The robot 510 is similar to the robot 10 described above in that it includes an engine 512, a carriage 516, a lower stabilizing mechanism 518, and an upper stabilizing mechanism 520. The lower stabilizing mechanism 518 and the upper stabilizing mechanism 520 are constructed and operate generally the same as described above. However, the carriage 516 in this embodiment includes tracks 517 (broadly “drive members”) instead of wheels. Extensions 519 are provided for spacing the tracks 517 from the sides of the engine 512 and positing the tracks below the engine. The extensions 519 position the tracks 517 for contacting the interior side surfaces of the pipe. The tracks 517 as shown are generally vertical but may be modified to angle outwardly like the wheel assemblies 40, 42 discussed above for enhancing contact with the side surfaces of the pipe. In use, the tracks 517 move the robot 510 forward and backward along the pipe, and the carriage 516, upper stabilizing mechanism 520, and lower stabilizing mechanism 518 enhance the stability and traction of the robot in the pipe. As evidenced by the robot 510 of this and the prior embodiments, features of the present invention, including the carriage, the lower stabilizing mechanism, and the upper stabilizing mechanism, may be adapted for various types of robots.

Having described the invention in detail, it will be apparent that modifications and variations are possible without departing from the scope of the invention defined in the appended claims.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A robot for navigating a passageway having a longitudinal axis and an interior surface including upper and lower interior surface portions, the lower interior surface portion having a central segment corresponding to a radial position of about 6 o'clock in the passageway with respect to the longitudinal axis, and the lower interior surface portion having left and right side segments which are located clockwise and counter-clockwise, respectively, from the central segment with respect to the longitudinal axis, the robot comprising:
an engine having a front end, a rear end, and a travel axis along which the robot is adapted for traveling and which in use is positioned generally parallel with the longitudinal axis of the passageway;
a carriage connected to the engine, the carriage including drive members positioned on opposite sides of the carriage, the drive members being positioned for driving engagement with the interior surface of the passageway and being operatively connected to the engine for being driven by the engine to cause the robot to travel along the passageway via the driving engagement with the interior surface of the passageway;
a lower stabilizing mechanism adapted for maintaining the robot in a generally upright orientation in use as the robot travels along the passageway, the lower stabilizing mechanism extending downward for contacting the lower interior surface portion of the passageway to resist rotation of the robot in the passageway clockwise or counter-clockwise about the travel axis.

2. A robot as set forth in claim 1 wherein the lower stabilizing mechanism includes a positioning assembly extending downward below the engine and an engagement member connected to a lower end of the positioning assembly, the engagement member being adapted for engaging the lower interior surface portion of the passageway.

3. A robot as set forth in claim 2 wherein the lower stabilizing mechanism is adjustable between raised and lowered positions by actuating the positioning assembly for adjusting a vertical position of the engagement member with respect to the drive members of the carriage.

4. A robot as set forth in claim 3 wherein the lower stabilizing mechanism includes a scissors mechanism.

5. A robot as set forth in claim 2 wherein the engagement member comprises a wheel assembly including at least one wheel.

6. A robot as set forth in claim 5 wherein the wheel assembly includes an inner wheel and first and second outer wheels on opposite sides of the inner wheel, the inner wheel having a diameter which is greater than a diameter of the first outer wheel and greater than a diameter of the second outer wheel.

7. A robot as set forth in claim 3 wherein the engagement member is positioned in use to be spaced above the central segment of the lower interior surface portion of the passageway when the engagement member is at a radial position corresponding to about 6 o'clock in the passageway with respect to the longitudinal axis of the passageway, and the engagement member is positioned to engage the left and right side segments of the lower interior surface portion of the passageway when the engine rotates clockwise and counter clockwise, respectively, about the travel axis of the engine.

8. A robot as set forth in claim 1 wherein the dive members each have an axis of rotation which is positioned at an angle between about 10 degrees and about 45 degrees with respect to horizontal.

9. A robot as set forth in claim 1 further including an upper stabilizing mechanism extending upward for contacting the upper interior surface portion of the passageway.

10. A robot for navigating a passageway having a longitudinal axis and an interior surface including upper and lower interior surface portions, the robot comprising:
an engine having a front end, a rear end, and a travel axis along which the robot is adapted for traveling and which in use is positioned generally parallel with the longitudinal axis of the passageway;
a carriage connected to the engine, the carriage including drive members positioned on opposite sides of the carriage, the drive members being positioned for driving engagement with the interior surface of the passageway and being operatively connected to the engine for being driven by the engine to cause the robot to travel along the passageway via the driving engagement with the interior surface of the passageway;
an upper stabilizing mechanism extending upward for contacting the upper interior surface portion of the passageway.

11. A robot as set forth in claim 10 wherein the upper stabilizing mechanism includes a support assembly and an engagement member adapted for engaging the upper interior surface portion of the passageway.

12. A robot as set forth in claim 11 wherein the engagement member comprises a wheel adapted for engaging and rolling along the upper interior surface portion of the passageway as the robot travels along the passageway.

13. A robot as set forth in claim 11 wherein the support assembly is configured to bias the engagement member upward for maintaining engagement of the engagement member with the upper interior surface portion of the passageway.

14. A robot as set forth in claim 13 wherein the support assembly is configured for biasing the engagement member upward against the upper interior surface portion of the passageway with sufficient force to increase traction of the drive members of the carriage on the interior surface of the passageway.

15. A robot as set forth in claim 13 wherein the support assembly is configured to permit the engagement member to deflect away from the upper interior surface portion in response to the engagement member engaging an irregularity in the upper interior surface portion of the passageway as the robot travels along the passageway.

16. A robot as set forth in claim 13 wherein the support assembly includes an arm and a piston, the arm being movable between raised and lowered positions, and the piston being operatively connected to the arm to bias the arm toward the raised position.

17. A robot as set forth in claim 10 wherein the dive members each have an axis of rotation which is positioned at an angle between about 10 degrees and about 45 degrees with respect to horizontal.

18. A robot for navigating a passageway having a longitudinal axis and an interior surface, the robot comprising:
an engine having a front end, a rear end, and a travel axis along which the robot is adapted for traveling and which in use is positioned generally parallel with the longitudinal axis of the passageway;
a carriage connected to the engine, the carriage including wheel assemblies positioned on opposite sides of the carriage, the wheel assemblies being positioned for driving engagement with the interior surface of the passageway and being operatively connected to the engine for being driven by the engine to cause the robot to travel along the passageway via the driving engagement with the interior surface of the passageway, the wheel assemblies each including an inner wheel and an outer wheel, the inner wheel having a first diameter and the outer wheel having a second diameter smaller than the first diameter.

19. A robot as set forth in claim 18 wherein the inner wheels are wider than the outer wheels.

20. A robot as set forth in claim 18 wherein each wheel assembly has a radially outward facing circumferential bearing surface and the bearing surfaces of the inner and outer wheels of each wheel assembly provide the wheel assembly with a tapering bearing surface which has a first diameter adjacent a proximal end of the tapering bearing surface adjacent the engine and a second diameter adjacent a distal end of the tapering bearing surface which is greater than the first diameter.
